(19) United States
(12) Patent Application Publication
(10) Pub. No.: US 2009/0048939 A1
(43) Pub. Date: Feb. 19, 2009

(54) Method and System for Handling Media Files

(75) Inventor: Christopher A. Williams, Glassboro, NJ (US)

Correspondence Address: FLASTER/GREENBERG P.C.;8 PENN CENTER, 1628 JOHN F. KENNEDY BLVD., 15TH FLOOR, PHILADELPHIA, PA, 19103, US

(73) Assignee: O D S, Inc., Glassboro, NJ (US)

(21) Appl. No.: 12/189,643

(22) Filed: Aug. 11, 2008

Related U.S. Application Data
(60) Provisional application No. 60/964,234, filed on Aug. 9, 2007.

(51) Int. Cl. G06F 15/16; G06Q 30/00

(52) U.S. Cl. 705/26; 709/217

(57) ABSTRACT

The invention includes methods and systems useful in the handling of media files. Provided are methods for providing media content to a user including storing media content items in a first computer; adapting the first computer to allow the user to access the media content items from a second computer through a network; adapting the first computer to allow the user to select some or all of the media content items; adapting the first computer to allow the user to arrange the media content items in any order that the user desires; and downloading the selected and arranged media content items to the second computer. Related systems and methods are also disclosed.

### BACKGROUND OF THE INVENTION

1. Field of the Invention

The present invention pertains to handling and managing media files, particularly to handling, transferring, manipulating and managing video and audio files to provide a customized sequence of files or clips and more particularly a customized sequence of clips that pertain to exercise.

2. Description of Related Art

Exercise routines and instructions have been recorded and filmed and sold in the form of audio and video tapes and as digital virtual disks or DVDs. Exercise routines and instructions have also been offered through the internet. For example, U.S. Patent Application Publication No. 20060265730, which is incorporated by reference and which is entitled “Mixing and Producing Individualized Media Files,” describes in its abstract “a web-based interactive fitness program for generating individualized fitness media content for subscribers. A database is maintained that includes scriptlets that identify exercise routines that have been provided or augmented by a trainer. One or more of the scriptlets are selected for a subscriber based on the subscriber's information. The selected scriptlets are then compiled into media content that is delivered to the subscriber for use.”

This Patent Application Pub. No. 20060265730, which lists as inventors Hays and Wesemann, pertains to “a method of creating individualized media content for a subscriber . . . comprising processing individualized subscriber attribute information in a knowledge base module . . . ; comparing the subscriber attribute information with at least metadata describing the pre-defined content to identify one or more media clips that match the individualized subscriber attributes information; creating a clip list including the one or more media clips based on the matching scriptlet identification information; and transmitting the clip list to the subscriber.” Claim 1. While prior art methodology has become quite sophisticated in this field, further improvements can be made.

### BRIEF SUMMARY OF THE INVENTION

The invention includes methods and systems useful in the handling of media files. In an embodiment, the invention provides a method for providing media content to a user including storing media content items in a first computer; adapting the first computer to allow the user to access the media content items from a second computer through a network; adapting the first computer to allow the user to select some or all of the media content items; adapting the first computer to allow the user to arrange the media content items in any order that the user desires; and downloading the selected and arranged media content items to the second computer.

The invention includes a system for delivering media content to a user. Such system includes a first computer adapted to store media content items; and a second computer in communication with the first computer through a network. The second computer is remote from the first computer, the first computer is adapted to allow a user to select and arrange some number of the media content items to form a first premix; and the first and second computers and the network are adapted to allow the user to download the first premix from the first computer to the second computer.

Computer-implemented methods for providing exercise video segments to a user are also disclosed. These computer-implemented methods include providing exercise video segments in a first computer; connecting the first computer to a network of remote computers through the internet; programming the first computer to allow the user to select and arrange exercise video segments to form a customized workout video; and programming the first computer to allow the user to purchase and download the workout video.

The invention includes methods for providing media content to a user including storing media content items in a first computer; adapting the first computer to allow the user to access the media content items from a second computer through a network; adapting the first computer to allow the user to select some or all of the media content items; adapting the first computer to allow the user to download the selected media content items to the second computer; and adapting the first computer to download with the selected media content items software or code that the user can use for arranging the selected media content items.

Also included within the scope of the invention are systems for delivering media content to a user. Such systems include a first computer adapted to store media content items; and a second computer in communication with the first computer through a network, the second computer being remote from the first computer; wherein the first computer is adapted to allow a user to select some number of the media content items; wherein the first and second computers and the network are adapted to allow the user to download the selected media content items from the first computer to the second computer; and wherein the first computer is adapted to download software to the second computer that provides capability in the second computer so that the user can sort, select, move, remove and/or arrange the media content items in the second computer.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. A better understanding of the invention can be obtained when the detailed description of exemplary embodiments set forth below is considered in conjunction with the attached drawings in which:

FIGS. 1-3 are screen prints of internet web pages, according to the present invention.

FIGS. 4-10 provide flow charts for developing software to provide an internet web site according to the present invention.

### DETAILED DESCRIPTION OF THE INVENTION

The present invention pertains to handling, transferring, manipulating and managing video and audio files to provide a customized sequence of files or clips. In one embodiment, the present invention pertains to fitness software that can manage a person's workouts and fitness goals. More particularly the invention allows a user the ability to custom design his or her own workouts by blending and creating seamless video and audio files that are unique.

In one embodiment, the present invention provides a system and method for managing a user's workouts and weight loss program on the user's computer or like device and allows the user the ability to instantly digitally download video and audio files. One of the features of the invention is it allows the user to download video or audio files and mix them in any desired order the user chooses, thus creating almost unlimited and unique custom workouts. The invention empowers the user with the ability to create a workout that is specific to his or her needs, wants and abilities. Video and audio files are seamlessly joined together, creating one seamless video or audio file that can then be instantly viewed. Video workouts are encoded in a full-length version and in smaller segments called “chapters” to make it possible for the user to create his or her own premixes.

The invention also allows the user the ability to easily share his or her custom-made workouts with friends and other online exercisers. The invention also uniquely allows the user the ability to sort video and audio clips by numerous methods including, but not limited to, the following: title, length, equipment used, fitness level, instructor, muscle group, type and calories burned. The invention also keeps track of important data such as calories burned and workout length and frequency. This information is tracked and stored in a database by the invention and is used to help a user plan and reach fitness goals.

Methods and systems according to the present invention not only help a user track and plan a fitness and/or weight-loss program, but also provides the user with an almost unlimited ability to instantly download and arrange video and audio clips creating customized and unique workout programs. While the embodiments described herein pertain to exercise, alternative embodiments of the invention may also be used by anyone wanting to combine video and audio files for other purposes, so the present invention is not limited to exercise or weight loss.

In a preferred embodiment, a user who exercises at home or otherwise alone can create a workout or exercise program that is truly specific to his or her needs, and the program can be modified or changed easily with little effort by the user. A good aerobics instructor constantly varies the content and music in his or her class to keep class participants motivated and enthused. On the other hand a consumer purchasing a fitness DVD or video is usually stuck doing the same routine over and over. Thus, enthusiasm and motivation decrease over time and the consumer usually stops working out. The present invention solves this problem by allowing the user the ability to easily change his or her workout routine as often as desired through uniquely chaptered digital downloads that the user can arrange in any desired order. Since files are digitally downloaded and have been uniquely broken into chapters, the user can add to his or her video and audio library at any time and from anywhere.

The present invention further helps to keep a user motivated to exercise. Users can share workouts with other online users and can communicate online in a discussion forum according to the present invention. Since users can easily share the workouts they have created with other online users and can communicate online in discussion forums, users have an almost unlimited support group of people who have a similar interest.

Blending

The present invention allows a user to construct his or her own unique or customized workout from thousands of video clips encoded on a web server. Every workout can be downloaded in its full length version (usually 45 to 90 min.) or may be downloaded by an exercise or cardio or other segment (called a “chapter”). Video footage is delineated into chapters, and a marker is embedded in the video at the beginning and/or end of a chapter, which can be detected by using a software routine. The embedded markers make it possible to divide video footage into chapters, and chapters make it possible for the user to construct his or her own customized workout. The present invention allows the user to decide precisely what he or she wants as a workout program, and the user can change the workout program using his or her own computer.

Video footage has been recorded in the past on tape and DVDs, and video footage on DVD has been delineated into chapters. In a “premix” of video footage on a DVD, it has been possible to rearrange the exercise segments on the DVD in different ways to create different workouts from the same footage. A DVD premix is not only limited to the video footage available on the DVD, but a DVD premix is also limited due to a limited number of variables that can be manipulated, which limits the number of chapters that can be delineated and/or manipulated to change to a new workout.

The present invention allows a user to download from one computer, such as a computer hosting a website that provides exercise video footage (as well as audio footage), to his or her computer over a communication system, such as an internet or a telephone network or through a wireless communication system. The user's “computer” can be any one of a variety of electronic storage devices. Any amount of video and any number of chapters can be downloaded from a hosted website that provides video and/or audio to consumers for free or paid download. With digital downloads the present invention allows a consumer to construct an essentially infinite number of premixes since the only limitation is what the consumer chooses to download and arrange as a premix, which may be limited by what is available on the website and by what the consumer chooses to spend in the case of downloads that are not free. While a DVD premix is provided by a vendor, a premix according to the present invention is performed by a consumer.

A computer and software system designed according to the present invention makes it easy for a user to download and organize video clips. The user can arrange and mix the clips in any order he or she wants to create his or her own customized workout. If video footage is merely cut into segments, which are then rearranged, the resulting footage would be disjointed, choppy and rough. The same could be true of downloading an exercise video or a set of instructions that is divided into chapters. In the present invention however the computer and software system will automatically insert a transition or segue between video clips, or the user can insert an information card between segments. The transition may be a fade to black or a blend of scenes or some other mechanism that makes viewing a series of video clips smooth and pleasing to the eye (and to the ear). An information card can be used instead of or in addition to a transition such as a fade to black. An example of an instruction card is an audio or video segment informing the user to get a piece of equipment for a next phase of the workout.

In a preferred embodiment a user selects video segments on a website, chooses for transitions to be provided between the video segments and clicks on a merge button, and all the clips are merged into one seamless MP4 file (MPEG video layer 4 or a similar technology) with a smooth transition between each video segment. The user can then play the MP4 (or similar) file on a digital device of his or her choice. The video segments flow smoothly through the transitions so that the combined video (and audio) footage is pleasing to the eye (and ear).

Sorting

Each video segment or clip will contain meta data such as a title for the clip, the length (time duration) of the clip, the level of difficulty of the exercise, equipment used to perform the exercise, calories burned in performing the exercise, etc. An intuitive software interface is provided so that a user can organize, choose and arrange the video clips. The sorting feature makes it easier for the user to organize the clips he or she downloaded previously and thus easier to construct his or her own customized workout. A user may have several thousand video clips, and the sorting feature provides a way for the user to easily construct a premix of video clips.

Tabulating

Data pertaining to a video clip can be associated with the video and encoded as meta data for the video clip. Mathematical data can be analyzed using standard techniques. As one example, each video clip of an exercise includes an estimate of calories burned in performing the exercise, and this data is stored as part of the meta data for the video clip. Every time a user creates a premix, the total calories burned can be calculated and displayed. This information is preferably stored in a database and presented so that the user can track his or her progress and plan future exercise routines.

Sharing and Communicating

After a user has created a customized workout routine, he or she can easily share the routine with other online users. Sharing is important as it helps users to form friendships and bonds with other users. The website hosting the video clips preferably offers a forum for online sharing of exercise routines. A challenge forum helps subscribers stay motivated and on track with their fitness programs. The present invention provides a user with the ability to share a premix that anyone can then download, which should be even more popular than just a forum where people can only talk about their routines. The host website preferably offers a chat room in which subscribers can discuss downloads, exercise routines, premixes, success stories, words of advice and anything else appropriate for such a forum.

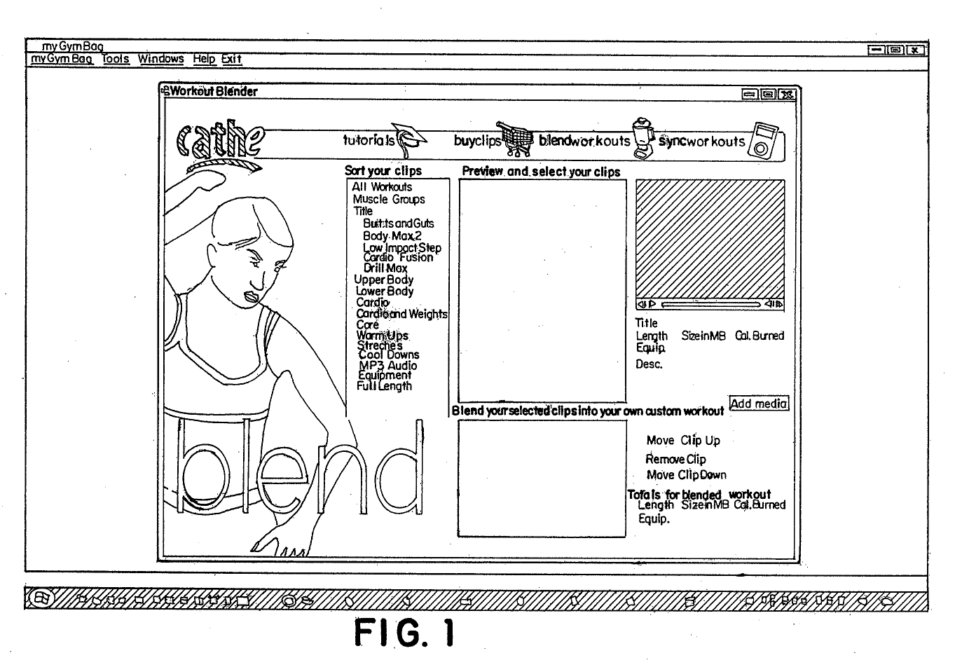

Turning now to the drawings, FIG. 1 is a screen print of an internet web page according to the present invention. FIG. 1 provides an example of an internet web page that a media provider may host in order to provide a store front from which consumers or users may purchase media files, particularly video files or clips. The web page is entitled “Workout Blender.” A row of selection buttons is provided along the top, including “tutorial,” “buy clips,” “blend workouts” and “sync workouts.” The button to “blend workouts” has been selected. A picture of an exercise leader is provided on the left of the screen under the title “cathe,” which can be the leader's name, and the word “blend” overlays the picture in white letters. A box labeled “1” to the right of the picture is entitled “Sort your clips.” The following selections are provided in box 1: All workouts, Muscle Groups, Title (and under Title: Butts and Guts, Body Max 2, Low Impact Step, Cardio Fusion and Drill Max), Upper Body, Lower Body, Cardio, Cardio and Weights, Core, Warm Ups, Stretches, Cool Downs, MP3 Audio, Equipment and Full Length. A box labeled “2” is provided to the right of box 1 and is entitled “Preview and select your clips.” Box 2 is presently empty. A movie or preview screen is provided to the right of box 2 for previewing clips. Below the movie screen, information is provided including the title of the clip, its length, size in mega bytes (MB), an estimate of calories burned if the exercise is performed, equipment needed to perform the exercise and a description of the video clip. A box labeled “3” is provided below box 2 and is entitled “Blend your selected clips into your own custom workout.” Box 3 is presently empty. Selection button tools are provided to the right of box 3 to allow the user to manipulate selected clips, including “move clip up,” “remove clip” and “move clip down.” “Totals for blended workout” is provided below the selection buttons for arranging the order of the clips and provides a summation of length, size in MB, calories burned and equipment needed. A selection button is provided to the right of the title for box 3 and is labeled “Add media,” and selection allows the user to add music to the workout video that is to be created.

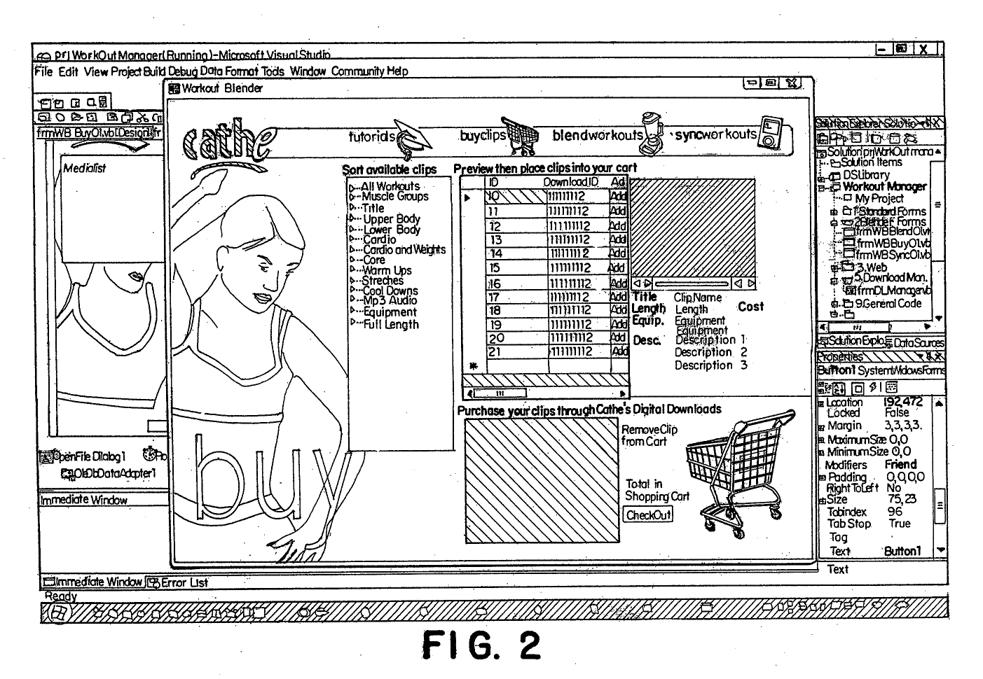

FIG. 2 is a screen print of a web page that is provided after the user points a cursor and clicks at the “buy clips” selection button shown in FIG. 1. The word “buy” overlays the picture of “cathe” on the lower left portion of the screen. The layout and appearance of FIG. 2 is essentially the same as for FIG. 1, except a shopping cart is pictured in the lower right side of the screen. Box 1 is labeled “Sort available clips.” Box 2 is labeled “Preview then place clips into your shopping cart,” and box 3 is labeled “Purchase your clips through Cathe's Digital Downloads.” Clips can be added to or removed from the shopping cart, and a total number of clips selected is provided next to the shopping cart. The cost of a selected clip is provided under the movie screen. A user selects a type of video clip in box 1 such as “Stretches,” and video clips of stretches are provided in box 2. Clicking on a clip in box 2 plays the clip on the movie screen. Selecting an “add” button in box 2 to the right of an “ID” and a “DownloadID” for the clip adds the clip to the shopping cart for subsequent purchase. Box 3 displays the clips that have been selected for purchase. The screen print in FIG. 2 overlays a screen of “Microsoft Visual Studio” used to build the “Workout Blender” screen of FIG. 2. While the “Workout Blender” screen would be displayed on a user's computer over an internet network, the “Microsoft Visual Studio” screen would not be seen by the person purchasing video clips.

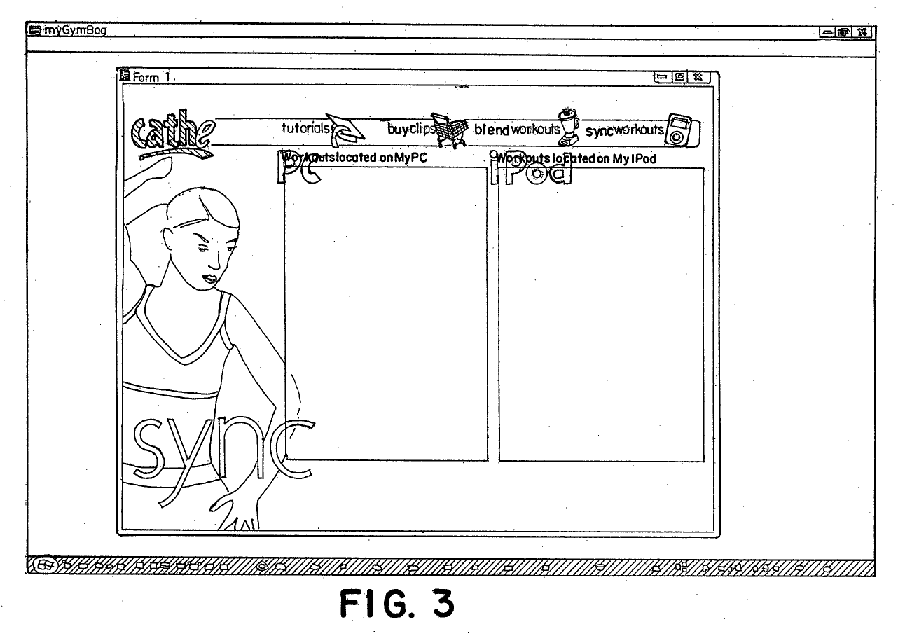

FIG. 3 is a screen print of a web page that would be seen by the user after the “sync workouts” button is selected. The word “sync” overlays the picture of “cathe” on the lower left side of the screen and is shown in a contrasting color, which is depicted as a grayscale in FIG. 3. Two boxes labeled “PC” and “iPod” are provided to the right of the picture of “cathe” and below the “tutorial,” “buy clips,” “blend workouts” and “sync workouts” buttons. The “PC” box is entitled “Workouts located on MyPC,” and the “iPod” box is entitled “Workouts located on MyiPod.” “PC” refers to the user's personal computer. The label “iPod” refers to the user's iPod® media storage device, where “iPod” is a registered trademark of Apple Computer, Inc. for portable and handheld digital electronic devices and computer software for recording, organizing, transmitting, manipulating, and reviewing audio and/or video files. The “PC” and the “iPod” boxes allow the user to synchronize a video clip file just purchased with the user's PC or iPod.

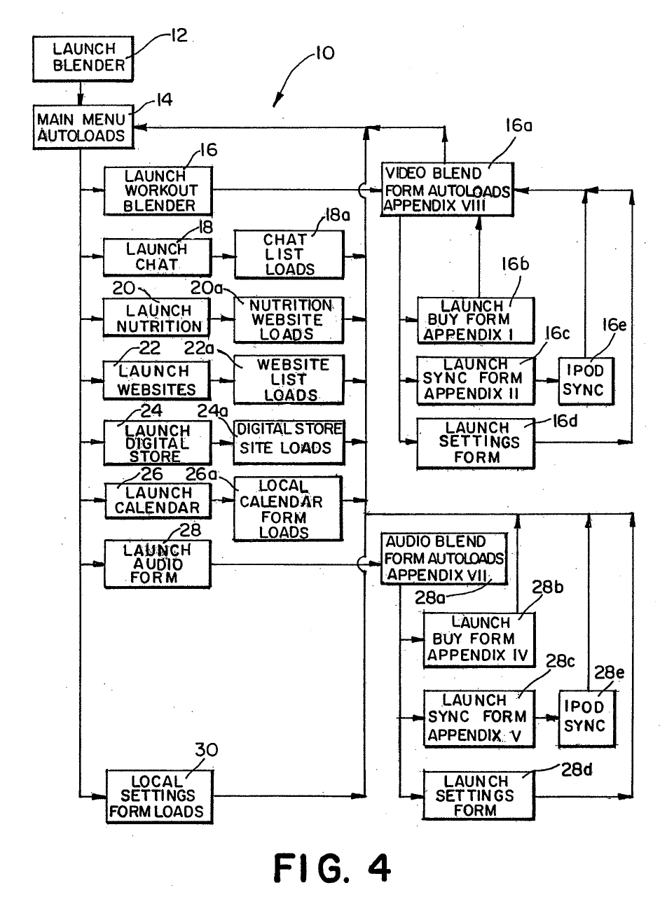

FIG. 4 provides a flow chart 10 for developing software to provide an internet web site according to the present invention. The present invention gives consumers the ability to choose many options to help them with their workouts and fitness goals. A consumer can launch in step 12 a workout blender, which provides them with audio and video clips that will allow them to create their own custom workouts from a main menu after the menu loads in step 14. From the main menu, the consumer can launch a workout blender 16, a chat session 18, a nutrition program 20, other websites 22, a digital store 24, a calendar 26, and an audio form 28. Step 30 provides local settings for form loads. If the consumer launches workout blender 16, a video blend form 16a loads automatically. From video blend form 16a, the consumer can launch a buy form 16b, a sync form 16c and a settings form 16d. A download can be synchronized with a list in an iPod in a step 16e. Launching chat 18, nutrition 20, websites 22, store 24 or calendar 26 loads a web site or page in a subsequent step identified by the same number with the suffix “a” in steps 18a, 20a, 22a, 24a and 26a. Launching audio form 28 causes audio blend form 28a to load. From audio blend form 28a, the consumer can launch a buy form 28b, a sync form 28c and a settings form 28d. A download can be synchronized with a list in an iPod in a step 28e.

The present invention gives the consumer the ability to launch a web-based chat program 18, which will allow them to communicate in real time with other people with similar goals to assist in motivation and other aspects of the workout manager. Consumers can use the web-based nutrition software application 20 to track the foods they are eating and the nutritional value of their meals to help coordinate effective weight loss goals. The website list 22 contains various websites that are pertinent to the workouts and fitness. Digital Store 24 provides all the available video and audio files available for purchase, as well as other files. Workout calendar 26 helps to track the fitness progress and goals of a user and how many calories are being burned and consumed over a certain period of time.

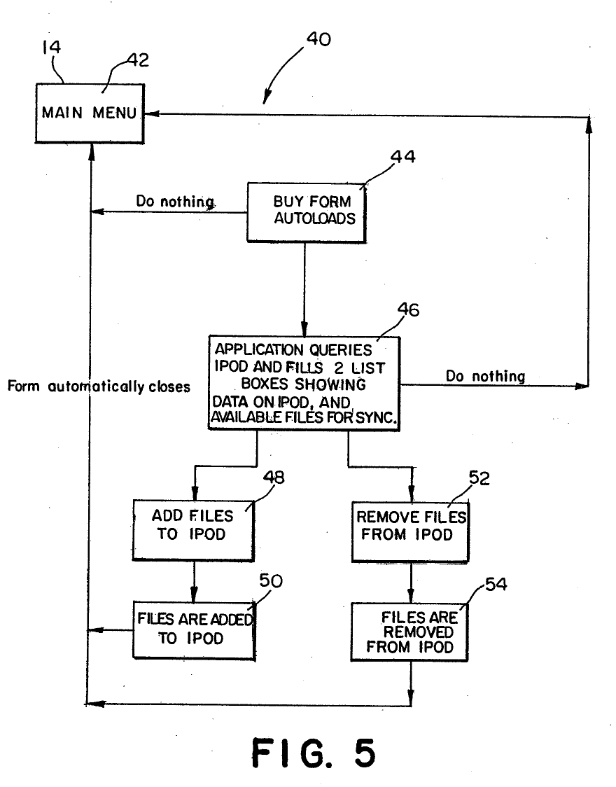

FIG. 5 provides a flow chart 40 for developing software for a video purchase form according to the present invention. Thus, the invention gives the consumer the ability to purchase video clips via an online database. From a main menu 42, which may be the same as main menu 14 in FIG. 4. Main menu 42 may be displayed as a home page for a website such as depicted in FIG. 1. If the consumer selects the “buy clips” button in FIG. 1, a buy form 44 loads automatically. The consumer can purchase video clips as described with reference to FIG. 2 above. With reference to FIG. 5 and after the consumer connects his video-capable iPod (currently using MP4 technology) to his computer, an application 46 queries the iPod and lists the relevant contents of the iPod on the web page that the consumer is viewing.

With reference to FIG. 5 (and to FIG. 2), when buy form 40 auto loads, the application automatically queries the database and through queries breaks down the available categories that the consumer can choose from. The consumer then clicks on the desired selection, and the video auto plays in the video preview window on the form. If the consumer wishes to purchase the file, he or she then clicks the add button which transfers in step 48 the filename to a list box. Once the consumer is satisfied with the selection of items to purchase, the consumer then goes to checkout. Tokens can be purchased and used for purchasing video files. An appropriate number of tokens is removed from the account, and the files download automatically in step 50 to the required directory by the application. If the consumer does not have enough tokens, he or she will also be able to purchase tokens from this screen. The consumer can choose to remove files from his or her iPod in step 52, which is then carried out in step 54.

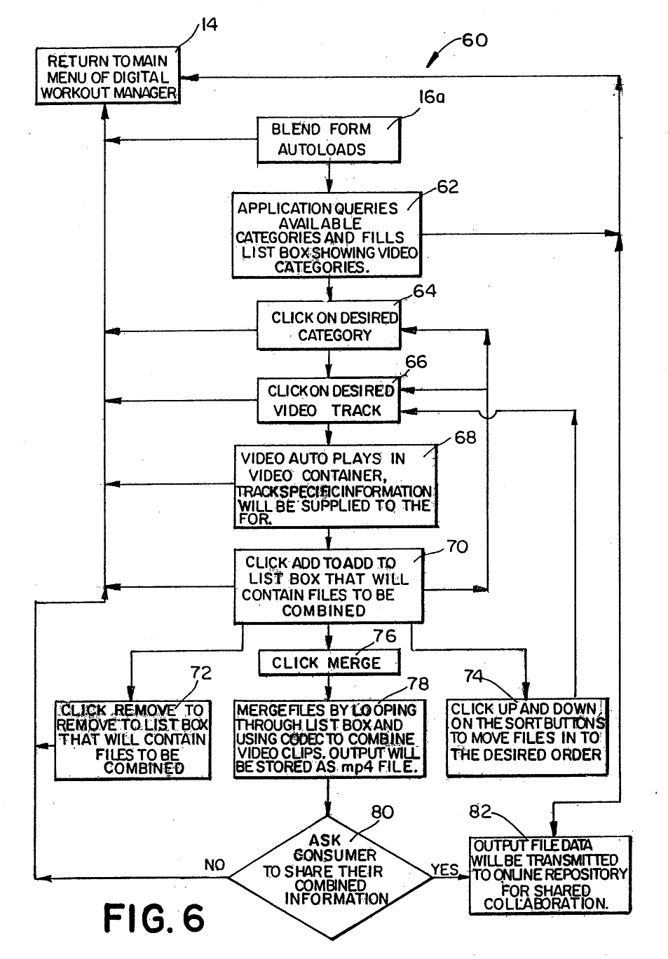

With reference to FIG. 6 and continuing to reference FIG. 1, a flow chart 60 provides guidance for developing software according to the present invention. From the main menu 14, if the consumer clicks on the “blend workouts” button shown in FIG. 1, which is step 16 in FIG. 4, a blend form loads automatically in step 16a as described with reference to FIG. 4 above. The application queries available categories in a step 62 and fills a list box such as box 1 in FIG. 1 to display video categories. The user clicks on a desired category in step 64, which lists video clips within that category in box 2 of FIG. 1. The user can then click on a video clip in step 66, and that clip plays in the movie screen in step 68 and displays information about the clip in fields below the movie screen in FIG. 1. An “add” button such as the one shown in box 2 of FIG. 2 allows the user to select a video track in step 70. Step 72 corresponds to the remove button discussed above with reference to FIG. 1, and step 74 corresponds to the buttons for moving a clip up or down within a list. A merge step 76 merges files in step 78 by looping through the list box and using a software code, or more specifically a type of MP4 file, called “codec” to combine video clips. An MP4 codec is a mathematical algorithm that compresses a video file into a smaller size. An MP4 codec from a company called 3ivx Technologies Pty. Ltd. of Sydney, Australia can be used. A company called MainConcept offers a video encoder-decoder software that can be used to practice the present invention. Codec technology is available from a number of different companies and is a developing technology. In any case output is stored as an MP4 file, and the consumer is asked in step 80 whether he or she wishes to share the file with others through an online forum provided by the media provider who provides the website illustrated in FIGS. 1-3. If the user chooses to share the file, in a step 82 the file data output is transmitted to an online repository.

Software according to the present invention should provide an interface that is easy to understand and easy to use. The software should allow a consumer to organize and sort MP4 files into any desired order. When all of the video clips are combined by merging in steps 76 and 78, a single new MP4 file using a 3ivx codec is created. The software, but not the 3ivx codec, provides the capability for combining, sorting, linking and organizing the video clips. The software preferably provides seamless transitions between the clips for a smooth and pleasing presentation, where without the transitions, the video file would present as disjointed and choppy.

The present invention gives the consumer the ability to blend video files together to create custom seamless workouts, which can be synchronized with, but not limited to, their computer, iPod®, Zune®, MP4 player, AppleTV or other handheld or digital device. (Zune is a registered trademark of Microsoft Corp.) When the blend form auto loads in step 16a, the application automatically queries a database of videos and, through queries, breaks down the available categories that the consumer can choose from. The consumer then clicks on the desired selection and the video auto plays in the video preview window on the form. If the consumer wishes to combine the file with another, the consumer clicks the add button, which transfers the filename to a list box. Once the consumer is satisfied with the selection of items to blend, the consumer clicks the merge button 76, and the files merge automatically to the required directory by the application. When the consumer blends the files together, the application tabulates meta data and calculates many aspects of the files including, but not limited to, calories burned, equipment used, and length of workout and level of workout. The application prompts the user to share their recent blending 80 with others so they can see the workout they have just created.

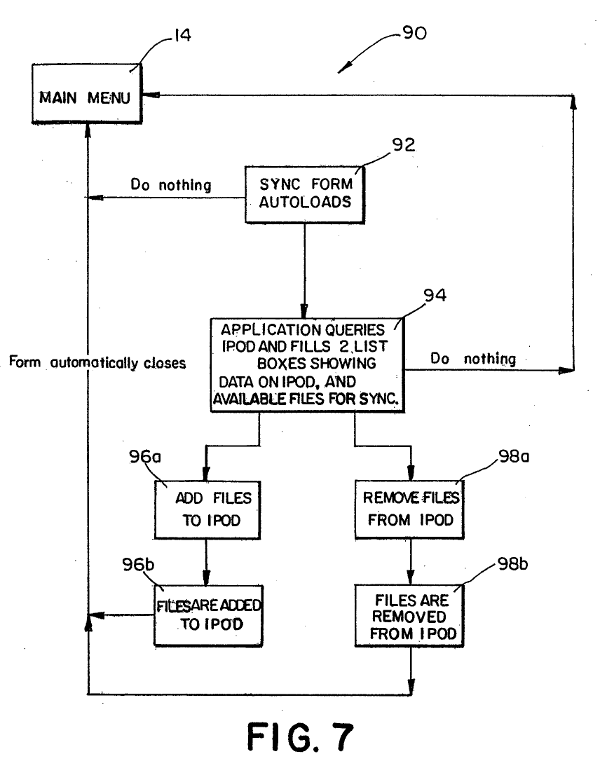

In FIG. 7, a flow chart 90 provides guidance for encoding software to synchronize video files. The present invention gives a consumer the ability to synchronize video files with his or her computer, iPod, AppleTV or other digital device. When the Sync Form auto loads in step 92, the application automatically queries in step 94 the iPod or digital like device and the database, which will determine what files can be added to or removed from the device. The consumer can then choose which files to add 96a, 96b or remove 98a, 98b by clicking the file names and then clicking add or remove.

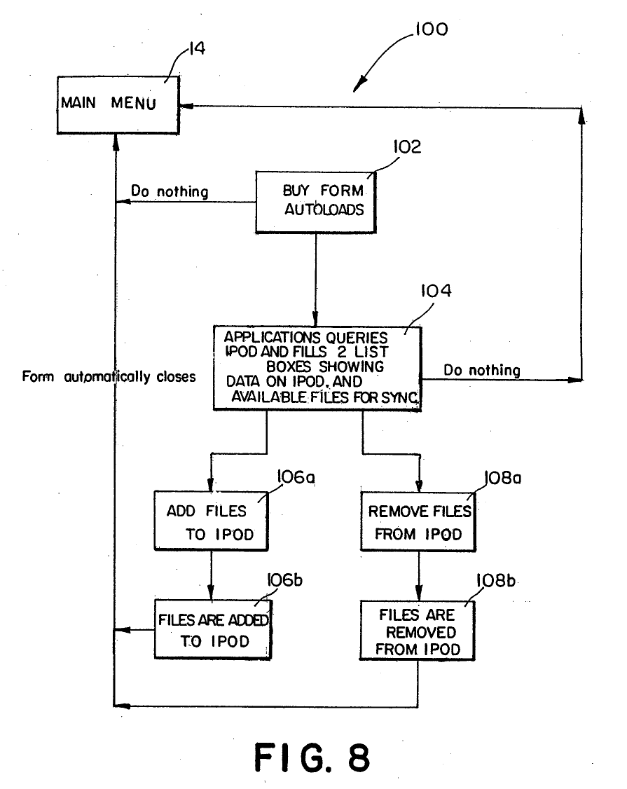

FIG. 8 provides a flow chart 100 for developing software to allow the consumer to purchase audio files that can be used with video clips. The invention gives the consumer the ability to purchase audio clips via an online database. When the buy form auto loads in step 102, the application automatically queries in step 104 the database and, through queries, breaks down the available categories that the consumer can choose from. The consumer then clicks on the desired selection and the audio auto plays in the preview screen on the form. If the consumer wishes to purchase the file, he/she then clicks the add button 106a, which transfers in step 106b the filename to a list box. Once the consumer is satisfied with the selection of items to purchase, the consumer checks out, and an appropriate number of tokens is removed from the account. File are downloaded automatically to the required directory by the application. If the consumer does not have enough tokens he/she will also be able to purchase tokens from this screen. Files can be removed in steps 108a and 108b.

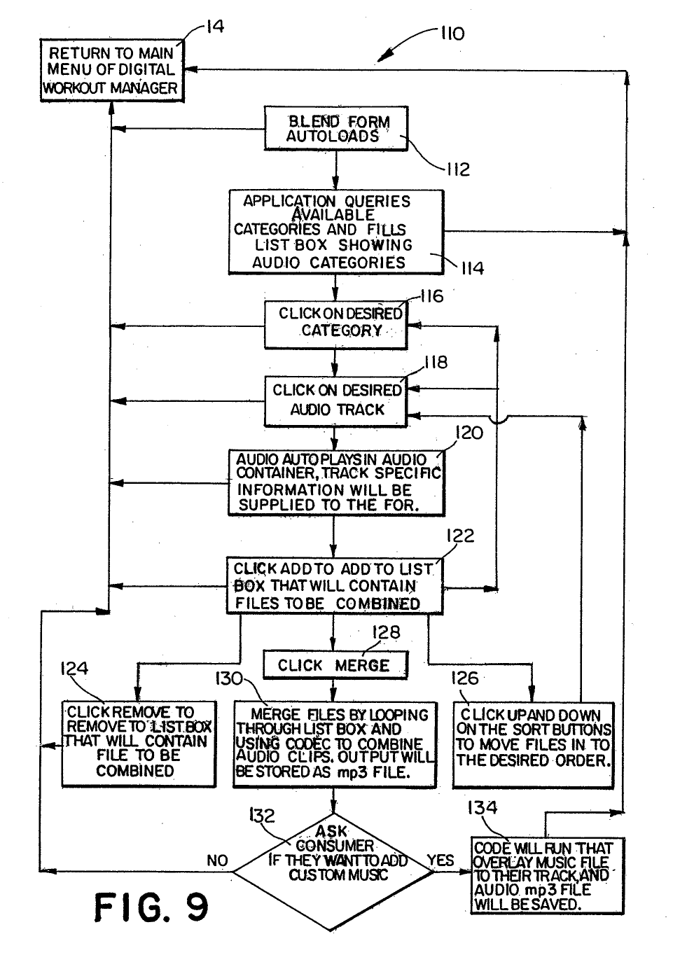

FIG. 9 provides a flow chart 110 for developing software to give the consumer the ability to blend audio files (vocals only or a mixed track of vocals and music) together to create custom workouts, which can be synchronized with their computer, MP3 player, iPod, AppleTV or other digital device. When an audio blend form auto loads in a step 112, the application automatically queries in step 114 a database and, through queries, breaks down the available categories from which the consumer can choose. The consumer selects (step 116) a desired category and then clicks (step 118) on a desired selection, and the audio auto plays (step 120) in an audio window provided on the form. If the consumer wishes to combine the file with another, the consumer clicks the add button (step 122), which transfers the filename to a list box. The consumer can remove (step 124) items and can move files into a desired order (step 126). Once the consumer is satisfied with the selection of items to blend, the consumer clicks the merge button (step 128), and the files are merged automatically to the required directory by the application (step 130). When the final file is completed, the consumer has the ability to add custom music to the file (step 132), and if music is added, code will run that overlays and saves a music audio MP3 file on a video MP4 track (step 134). When the consumer blends the files together, the application tabulates the data and calculates many aspects of the files including but not limited to, calories burned, equipment used, and length of workout and level of workout. The application will also prompt the user to share his/her recent blending with others so they can try the workout created by the user.

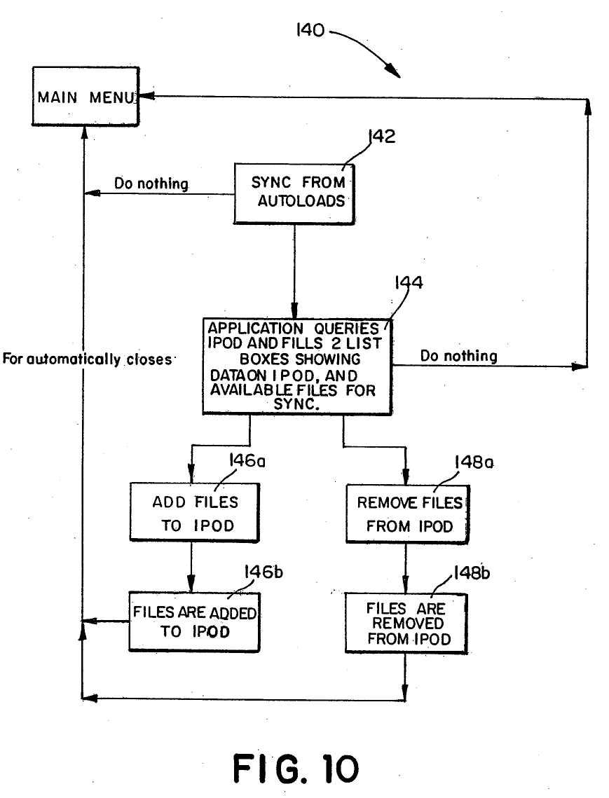

FIG. 10 provides a flow chart 140 for giving the consumer the ability to synchronize audio files with their computer, MP3 Player, iPod, AppleTV or other digital device. When an audio sync form auto loads in step 142, the application automatically queries (step 144) the iPod and database, which will determine what files can be added to or removed from the device. The consumer can then choose which files to add (steps 146a, 146b) or remove (steps 148a, 148b) by clicking the file names and then clicking add or remove.

A number of challenges were encountered and overcome during the development of this invention. It was found that when a file of video clips is downloaded to an iPod MP4 player and then played, a 2-second gap appears between sequential video clips. This challenge was overcome, and a file of video clips downloaded to an iPod MP4 player and then played according to the present invention does not have such gaps and instead flows seamlessly from clip to clip through smooth transition or segue snippets such as information cards and/or fade-outs.

Another challenge was that the playlist feature on a iPod does not allow one to easily sort video clips, and it is difficult to find a desired video clip. The present invention provides software on a website, which is easily accessible by users and which provides tools for sorting, selecting and arranging video clips easily and quickly. Further, an iPod is not a video editor and cannot be used to insert transitions between video clips and leaves a 2-second gap between video clips or segments. This type of editing capability, including sorting, arranging and inserting transition pieces between segments, is provided at the media provider's website. A single, merged MP4 video file can be downloaded to an MP4 iPod or similar device, which can be played without gaps between segments and instead with smooth transitions between segments.

The ability to add information and/or an instruction into a transition addresses the need that a user has with respect to knowing what equipment, such as dumbbells or a floor mat, is needed during an exercise workout. When making a premix of video clips that were never designed to be joined, there can be problems with users having enough time to get the equipment they need to perform the next exercise. The present invention allows a consumer to insert a predefined card or to make his or her own card that can be inserted easily between any two video segments. For example, if a user has just finished a segment of step aerobics and the next video segment requires a 40-lb. barbell, he or she can add a card anywhere from 3 to 30 seconds in length to allow time to get the barbell. The card can say “Curls are next, so get a 40-lb. barbell” or some similar wording, which flashes on a video screen between the aerobics segment and the barbell segment. This tells the user what equipment is needed next and allows him or her enough time to get the equipment.

A decline in the quality of video downloaded and played from a portable device was another challenge. After extensive experimentation, it was found that if one first decodes every video file and then re-encodes the video file using a high quality MP4 codec, then an output video file can be obtained that is as good as the original, separate video file segments. In developing the present invention, several improvements were made over the prior art. Exercise videos have been provided on DVDs, and users have been able to rearrange video segments within a DVD. However, the content of a DVD is limited, and there is a maximum of 16 variables that can be manipulated on a DVD, so there is a maximum of 16 video segments that can be blended or rearranged. The present invention can provide a truly extensive list, with no set limitation, of videos segments to choose from, arrange or blend and download. Thus, the number of premixes available is essentially limitless.

More recent prior art provides content on an internet website, and the content can be downloaded, but the content is believed to be is some cases limited to audio content that can be downloaded to an MP3 audio player and in some other cases limited to a selection chosen by someone other than the user. In the latter case it appears that a user answers queries or otherwise submits personal attributes to a media provider, and the media provider selects and arranges exercise video segments for the user to download and use without rearrangement. In contrast, the present invention gives total control to the user, and it is the user who selects and arranges a premix of video segments. With the present invention, the user can select and arrange video clips on the media provider's website, download the clips to his or her personal computer, and subsequently sort, select and arrange any number of the clips previously downloaded to provide variety in the user's workout program.

A further advantage of the present invention is that a user can easily share premixes online with others. Software provided in the present invention allows a user to post online with one click any premix the user has created. The user can post a premix or arrangement of exercise video clips with transition cards and snippets on a website, where the premix may then be viewed and searched by other online users. Sharing premixes is not only fun for a user, but also helps to keep users motivated.

The present invention has been described in terms of downloading video and audio clips from a host computer and arranging the clips, along with segues between the clips, on a user's computer to form a workout video, which may include the user's selected music. However, rather than a download, the media provider can sell the user a DVD. Current DVD content is in MP2 format. The present invention provides video content on a DVD in MP4 video format. Software can be provided with the DVD that gives the user capability to sort, select, add, remove and arrange video segments provided on the DVD to form a workout video and to include the user's choice of music in the workout video. The workout video can then be transferred to a portable MP4 capable video player such as an iPod or a Zune or a similar device.

In summary, the present invention provides a method executed using software and a system provided through computers, a network and/or portable electronic devices that allows a person to select, preview, purchase and download to his or her personal computer or personal handheld electronic device media files, particularly video and audio files. While the embodiments described herein pertain to exercise videos, other types of media content can be handled according to the present invention, such as instructional or informative media content such as sports training, museum tours and education that might otherwise be provided to a group in a classroom setting.

For the exercise application, the present invention allows one to sort, select, preview, arrange, purchase and download a fully customized selection and arrangement of exercise-related video clips. Transition snippets and/or information cards can be inserted automatically between video clips for a smoothly flowing video presentation of different exercise video clips, which may begin with a number of clips for stretches, include any desired number of exercise tasks and end with a number of clips for a cool-down period. The insertion of transition or segue snippets that include techniques such as a fade to black and a blend of frames as well as information or instructions such as “Get 20 lb. dumbbells” allows an essentially seamless presentation of video footage. Audio files, such as a user's favorite music tracks, can be overlaid on the video files so that the user can listen to his or her preferred music while exercising. The user can select and arrange a fully customized series of video clips that provide an exercise program (or any other media content), overlay his or her desired music on the clips, merge the selected and arranged video clips with transition clips that join the video clips in a manner so as to present the video in a smoothly flowing stream that does not appear to have abrupt changes between scenes, overlay an MP3 audio file if desired and download an MP4 video file or the like, which may include the MP3 audio file overlay. The MP4 video file can be downloaded first from the media provider's website to the user's personal computer, and then the user can download the MP4 file from the PC to a mobile, hand-held electronic device such as an iPod or other MP4 player or the like, which can be taken to a gym or other workout location. Data such as the number of calories consumed during a workout can be calculated using data associated with video clips as meta data. Customized arrangements of video clips can be shared over the internet or other network with others, and a chat room or similar forum allows users to communicate with each other to discuss topics of interest.

This invention has been described in connection with the preferred embodiments. These embodiments are intended to be illustrative only. In particular, although the preferred embodiments pertain to media content related to exercising, the scope of the invention includes any type of media content. Further, it will be readily appreciated by those skilled in the art that modifications may be made to these preferred embodiments without departing from the scope of the invention as defined herein. It is intended that all such variations within the scope and spirit of the invention be included within the scope of the appended claims.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I claim:

1. A method for providing media content to a user, comprising the steps of:
storing media content items in a first computer;
adapting the first computer to allow the user to access the media content items from a second computer through a network;
adapting the first computer to allow the user to select some or all of the media content items;
adapting the first computer to allow the user to arrange the media content items in any order that the user desires; and
downloading the selected and arranged media content items to the second computer.

2. The method according to claim 1, further comprising inserting a transition snippet between adjacent media content items.

3. The method according to claim 2, wherein the transition snippet is text.

4. The method according to claim 1, further comprising adapting the first computer to adapt the second computer such that the user can sort, select, move, remove and/or arrange media content items stored in the second computer.

5. The method according to claim 1, further comprising downloading the selected and arranged media content items from the second computer to a portable, hand-held electronic device.

6. The method according to claim 5, wherein the media content items comprise video files, and wherein the portable, hand-held electronic device is an MP4 capable video player.

7. The method according to claim 6, wherein the MP4 capable video player is an iPod®.

8. The method according to claim 6, wherein the media content items comprise video files, and wherein the video files pertain to exercising the human body.

9. The method according to claim 8, wherein the network is the internet.

10. The method according to claim 1, wherein the network is the internet.

11. A system for delivering media content to a user, comprising:
a first computer adapted to store media content items; and
a second computer in communication with the first computer through a network, the second computer being remote from the first computer;
wherein the first computer is adapted to allow a user to select and arrange some number of the media content items to form a first premix; and
wherein the first and second computers and the network are adapted to allow the user to download the first premix from the first computer to the second computer.

12. The system according to claim 11, wherein the second computer is adapted to allow the user to select and arrange some number of the media content items to form a second premix.

13. A computer-implemented method for providing exercise video segments to a user, comprising the steps of:
providing exercise video segments in a first computer;
connecting the first computer to a network of remote computers through the internet;
programming the first computer to allow the user to select and arrange exercise video segments to form a customized workout video; and
programming the first computer to allow the user to purchase and download the workout video.

14. The method according to claim 13, further comprising providing music audio tracks on the first computer, wherein the user can add music audio tracks to the workout video.

15. The method according to claim 14, wherein the music audio tracks are in an MP3 audio format, and wherein exercise video segments are in an MP4 video format.

16. The method according to claim 15, wherein the workout video comprises music audio tracks overlaid on exercise video segments.

17. A method for providing media content to a user, comprising the steps of:
storing media content items in a first computer;
adapting the first computer to allow the user to access the media content items from a second computer through a network;
adapting the first computer to allow the user to select some or all of the media content items;
adapting the first computer to allow the user to download the selected media content items to the second computer; and
adapting the first computer to download with the selected media content items software or code that the user can use for arranging the selected media content items.

18. The method according to claim 17, further comprising downloading and inserting a transition snippet between adjacent media content items.

19. The method according to claim 18, wherein the transition snippet is text.

20. The method according to claim 17, further comprising adapting the first computer to adapt the second computer such that the user can sort, select, move, remove and/or arrange media content items stored in the second computer.

21. The method according to claim 17, further comprising downloading the selected and arranged media content items from the second computer to a portable, hand-held electronic device.

22. The method according to claim 21, wherein the media content items comprise video files, and wherein the portable, hand-held electronic device is an MP4 capable video player.

23. The method according to claim 22, wherein the MP4 capable video player is an iPod®.

24. The method according to claim 25, wherein the media content items comprise video files, and wherein the video files pertain to exercising the human body.

25. The method according to claim 24, wherein the network is the internet.

26. The method according to claim 17, wherein the network is the internet.

27. A system for delivering media content to a user, comprising:
a first computer adapted to store media content items; and
a second computer in communication with the first computer through a network, the second computer being remote from the first computer;
wherein the first computer is adapted to allow a user to select some number of the media content items;
wherein the first and second computers and the network are adapted to allow the user to download the selected media content items from the first computer to the second computer; and
wherein the first computer is adapted to download software to the second computer that provides capability in the second computer so that the user can sort, select, move, remove and/or arrange the media content items in the second computer.
